(19) United States
(12) Patent Application Publication
(10) Pub. No.: US 2002/0034657 A1
(43) Pub. Date: Mar. 21, 2002

(54) Organic electroluminescence device

(75) Inventor: Kenji Mori, Tokyo (JP)

Correspondence Address: YOUNG & THOMPSON, 745 SOUTH 23RD STREET 2ND FLOOR, ARLINGTON, VA, 22202

(73) Assignee: NEC Corporation.

(21) Appl. No.: 09/915,452

(22) Filed: Jul. 27, 2001

(30) Foreign Application Priority Data
Jul. 27, 2000 (JP) 2000-227704

(51) Int. Cl. H05B 33/12

(52) U.S. Cl. 428/690; 428/917; 428/212; 428/213; 313/504; 313/506

(57) ABSTRACT

The present invention provides a an organic electroluminescent device including: an anode; a cathode; at least one luminescent layer disposed between the anode and the cathode, and the at least one luminescent layer including at least a host material represented by a general formula (20) and at least a dopant represented by a general formula (10); at least an electron transport layer between the at least one luminescent layer and the cathode, and the at least electron transport layer including at least a compound represented by a general formula (30).

### BACKGROUND OF THE INVENTION

1. Field of the Invention

The present invention relates to an organic electroluminescence device, and more particularly to an organic electroluminescence device emitting a red-light and the organic electroluminescence device may be utilized for in-plane light sources or display devices.

2. Description of the Related Art

The electroluminescence devices are promising devices for a self-emission type plane display. The electroluminescence devices are classified into an organic electroluminescence device and an inorganic electroluminescence device.

The organic electroluminescence device is free from the requirement for alternating current drive at high voltage. The organic electroluminescence device is suitable for multi-light emissions due to a large variety of organic compounds. For this reason, the organic electroluminescence device is expected to be applied for full-color displays. The organic electroluminescence device has been developed to have a high luminance at a low driving voltage.

The inorganic electroluminescence device is excited by an electric field for emitting a light. In contrast, the organic electroluminescence device emits a light upon carrier injections, wherein holes are injected through an anode, whilst electrons are injected through a cathode. The injected holes and electrons are then moved toward the cathode and the anode, respectively, whereby recombination of electrons and holes appears to form excitons. The excitons are then relaxed to emit a light as the luminescence.

Formally, a high purity anthracene single crystal was used to study the organic electroluminescence device. The old device is poor in luminance and luminescent efficiency even upon a high voltage application, and also poor in stability.

In 1987, Tang et al. of Eastman Kodak announced that a double layered structure of organic thin films allows a highly bright and stable luminescence, and reported this in Applied Physics Letter 51(12) p-913 in 1987. A lamination of a luminescence layer and a hole transport layer is disposed between paired electrodes or the anode and the cathode. This structure provided 1,000 cd/m2 at 10 V applied voltage. After this announcement, the research and development of the organic electroluminescence device have become active.

Recently, it has been proposed to further interpose an electron transport layer between the cathode and the luminescent layer or interpose a hole injection layer between a hole transport layer and the anode, in addition to the luminescent layer and the hole transport layer.

Materials of the respective layers of the device and the combined sage of the materials for the respective layers have been investigated, as a result of which, the luminescence efficiency and the life-time of the device have been improved. The organic electroluminescence device has greatly been expected to be applied for a flat panel display having a two-dimensional array of the devices. The flat panel display may be either monochrome or color display. The conventional techniques are disclosed in Nakata et al. “display and imaging” col. 5, pp. 273-277 (1997), and also disclosed in Nakata “fundamentals and practical application of organic EL display” Applied Physics, organic Molecule Bio-electronics SC Text for sixth lecture, pp. 147-154 (1997). This conventional technique is further disclosed in “Flat Panel Display 1998” pp. 234 (Nikkei BP).

The three primary colors, red-green-blue, are necessary for the color display panel. The three primary colors may be obtainable by combining a white luminescence device with color filters. Alternatively, the three primary colors may also be obtainable by a color-change from a blue light emission device, wherein the blue light is higher in energy than the remaining red and green lights. Further, alternatively, the three primary colors may also be obtainable by using red, green and blue color luminescence devices,

The above first and second measures are easier in process than the above third measure since a white or blue color luminescence surface is formed on an entirety of the panel without separate applications of the three primary colors. The above first and second measures are, however, lower in an efficiency of taking out the luminescent energy with a large energy loss.

In contrast, the above third measure needs to separately apply the three primary colors. The above third measure is higher than the above first and second measures in the efficiency of taking out the luminescent energy. Accordingly, the above third measure is superior and advantageous in self-emission, provided that the three primary colors emission devices have high performances. The three primary color lights emission devices have been developed and exhibit somewhat high performances in luminance and luminescent efficiency. Particularly, the green-light emission device exhibits superior characteristics, wherein a luminescent layer comprises 8-quinolinol complex of aluminum doped with a quinacridone derivative. The blue-light emission device exhibits superior characteristics, wherein a luminescent layer includes a distyrylallylene derivative. Each of the characteristics has a maximum luminance which exceeds over a several tends thousands cd/m². The green-light and blue-light emission devices are practicable, but further improvements in the luminescence efficiency and the long life-time are desirable.

On the other hands, the development for the remaining red-light emission device has been delayed as compared to the above two types light emission devices. Even the research and development of the red-light emission device have been aggressive, the desirable characteristics and high performances have not yet been obtained, This is disclosed in “the remaining important issue and practical strategy” pp. 25-36.

Both doped-type and undoped-type red-color electroluminescent devices have aggressively been developed in the lights of high color purity, high luminescence efficiency and high luminance. The undoped-type red-color electroluminescent device has the luminescent layer made of a single luminescence material. The doped-type red-color electroluminescent device has the luminescent layer made of a host material doped with one or more luminescence materials as dopants.

For the undoped-type red-color electroluminescent device, a relatively highly color purity luminescent material has been founded out, but the luminance is too low to apply the same to a simple matrix driving display panel.

The doped-type red-color electroluminescent device has a relatively high luminance, but it is difficult to obtain both the high color purity and the high luminance. As a dopant concentration to the host material of the luminescent layer is high, the red-color purity of the red-color emitted light is high, but the luminance is low. In order to obtain a display panel with a wide region for color reproduction, it is essential to ensure the high luminance and the high color purity.

The followings are the conventional techniques for improving the high color purity, the luminance and the luminescent efficiency. Japanese laid-open patent publication No, 11-83749 discloses the use of Lumogallion metal complex. Japanese laid-open patent publication No. 11-273866 discloses the use of bis-2,5-(2-benzasoil)hydroquinone. Japanese laid-open patent publication No. 11-269397 discloses the use of phenoxazone compound, Japanese laid open patent publication No. 11-233261 discloses the use of dibenzotetraphenylperifurantene compound. Japanese laid-open patent publication No. 11-176572 discloses the use of 5-cyanopyrromethene-BF₂ complex. Japanese laid-open patent publications Nos. 2000-82583 and 6-93257 disclose the use of squallium compound. Japanese laid-open patent publication No. 11-144870 discloses the use of perylene derivative. Japanese laid-open patent publication. No. 11-144868 discloses the use of bianthlene compound Japanese laid-open patent publication No. 11-67450 discloses the use of teryleneimide derivative. Japanese laid-open patent publications Nos. 10-330743 and 10-60427 disclose the use of coumarin derivative. Japanese laid-open patent publication No. 10-308281 discloses the use of DCM derivative. Japanese laid-open patent publication No. 10-231479 discloses the use of Eu-derivative and imidazol derivative. Japanese laid-open patent publication No. 10-183112 discloses the use of quarterterilene derivative. Japanese laid-open patent publication No. 10-102051 discloses the use of terilene derivative. Japanese laid-open patent publications Nos. 10-36828, 10-36828 and 7-288184 disclose the use of phtharocyanine derivative. Japanese laid-open patent publication No. 9-323996 discloses the use of thiophene derivative. Japanese laid-open patent publication No. 9-296166 discloses the use of porphyrin derivative. Japanese laid-open patent publication No. 9-296166 discloses the use of nitrobenzothiazolylazo compound. Japanese laid-open patent publication No. 7-272854 discloses the use of phenoxazone derivative. Japanese laid-open patent publication No. 7-166159 discloses the use of 4hydroxyacridine metal complex. Japanese laid-open patent publications Nos. 11-124572 and 10-316964 disclose the use of thioxanthene derivative. Japanese laid-open patent publication No. 7-90259 discloses the use of violanthrone compound. International patent publication No. WO98/00474 discloses the use of porphyrin derivative. Japanese laid-open patent publications Nos. 2000-1225, 2000-1226, 2000-1227, 2000-1228, 11-329730, and 11-329731 disclose the use of di-styryl compound Japanese laid-open patent publications Nos. 11-335661, and 11-292875 disclose the use of methyne compound. Japanese laid-open patent publication No. 11-273865 discloses the use of ozazolone derivative. Japanese laid-open patent publication No. 11-193351 discloses the use of cyclic azine pigment.

It is difficult to apply the above conventional techniques to the color organic EL panel with the simple matrix driving system. In the simple matrix driving system, the time for luminescence of pixel is the reciprocal of the number of scanning lines. Talking an example of ¼ VGA panel with 320 by 240 dots, a maximum flash luminance of 24000 cd/m² is necessary for obtaining the pixel luminance of 100 cd/m², provided that 100 by 240 scanning lines.

Practically, an aperture efficiency, and a transmittivity of an anti-reflective filter are the relative factors to the luminance. The aperture efficiency is defined to be a ratio of a ratio of a luminescent region area to an entire region area. Actually, a higher luminance than 24000 cd/m² is necessary.

Alternatively, a dual scanning is available by a two-divided driving of the scanning electrodes with synchronization so as to make the necessary maximum flash luminance into a half of the above value. This dual scanning system is disadvantages in complication of the driving circuit configuration and difficulty in adjusting and combining the divided images.

Farther, alternatively, an active matrix driving is available to avoid shortening the light ON-time depending on the number of the scanning lines, wherein each pixel of the active matrix has a pair of transistor and a capacitor. It is difficult to prepare a substrate for mounting thin film transistors which drive the organic EL devices for causing current injection luminescence. The active matrix driving causes a cost-up as compare to the simple matrix driving.

Furthermore, for the simple matrix driving and the active matrix driving, it is desirable that the organic EL device has a high luminescent efficiency and a high luminance. Particularly, the high luminescent efficiency is necessary for reducing the power comsumption.

For preparing the color organic EL device with wide region for color re-production, it is essential to develop the high color purity of the luminescent device. In case of the red-color pixel, it is necessary that on “CIE1931” chromaticity coordinate, “x” is not less than about 0.62 and “y” is not more than about 0.38.

There had not been developed the device having both the high color purity and the high luminance. U.S. Pat. Nos. 4,769,292, 5,908,581, and 5,935,720 and, Japanese laid-pen patent publication No. 10-30821 disclose the use of dicyanomethylenepyrane derivative.

Indium thin oxide is used for the anode. N,N_-diphenyl-N,N_-bis(alpha-naphthyl)-diphenylbenzidine is used for the hole injection layer. Tris-(8hydroxyquinolato)aluminum is used for the host material of the luminescent layer. Tris-(8-hydroxyquinolato)aluminum will hereinafter be referred to as Alq3. Dicyanomethylenepyrane derivative is doped into the host material at a concentration of 0.9 percent by volume. Alq3 is used for the electron transport layer. A mixture of magnesium and silver at atomic ratio of 10:1 is used for the cathode. The color purity is relatively good, for example, (0.627, 0.369). A luminescent efficiency to the current is low, for example, 2 cd/A. If the color purity is dropped to (0.594, 0.397), the luminescent efficiency to the current is still low, for example) about 3.1 cd/A.

Japanese laid-open patent publication No. 11-329730 discloses the use of a specifically structured distyryl compound to obtain a high luminance of 11000 cd/m². A spectrum peak appears at 620 nanometers. It is presumable that the chromaticity is relatively good. The luminance is insufficient.

Japanese laid-open patent publication No. 10-284251 discloses the use of azobenzothioxanthene derivative. The host material of the luminescent layer is 8-hydroxyquinolinol gallium complex. The dopant is the azobenzothioxanthene derivative. The electron transport layer comprises 8-hydroxyquinolinol aluminum complex. The red-color purity is high. The luminescent efficiency to the injection current is less than 2 cd/A.

As described above, various materials have been developed to obtain desired performances and characteristics for practicing the red-light organic electroluminescent device. Further, various combinations of the materials for respective layers of the device have also been investigated. The simple matrix color organic EL panel has not yet been practiced in the ¼ VGA class. The combination of the dopant and the host material of Alq3 is disclosed in Japanese laid-open patent publication No. 11-335661, As compared to the conventional DCM, the higher luminance can be obtained. The disclosure is that the methine-based dopant is doped into the 8-quinolynol complex of aluminum, The disclosure does not suggest for the organic EL device nor suggest that the gallium complex compound is used for the electron transport layer. The maximum luminance is about 4000 cd/m2 at the color purity of about the chromaticity coordinate (0.61, 0.37)

Japanese laid-open patent publications Nos. 2000-68062, 10-88121; 11-67449 and Japanese patent No. 298269 disclose the materials for the electron transport layer and the high luminance and the high luminescence efficiency. Japanese laid-open patent publications Nos. 2000-68062 and 10-88121 and Japanese patent No 2982699 disclose that the gallium compound is used for the electron transport layer and the metal complex or the pyrane compound is used for the luminescent layer. Those publications do not teach the host and dopant materials with the specific chemical structures and combinations thereof for the luminescent layer, nor suggest for the high luminance, the high efficiency and the long life-time of the red-light emission device.

Japanese laid-open patent publication No. 11-67449 discloses that DCM as one of the pyrane compounds is used as a dopant. DCM is doped to the gallium complex as the host material.

As described above, various materials have been developed to obtain performances and characteristics insufficient for practicing the red-light organic electroluminescent device. Further, various combinations of the materials for respective layers of the device have also been investigated. Further improvements in the high luminescent efficiency, the high color purity and the high luminance as well as long durability of the red-light organic electroluminescent device.

In the above circumstances, the development of a novel red-light organic electroluminescent device free from the above problems is desirable.

### SUMMARY OF THE INVENTION

Accordingly, it is an object of the present invention to provide a novel red-light organic electroluminescent device free from the above problems.

It is a further object of the present invention to provide a novel red-light organic electroluminescent device improved in high luminescent efficiency.

It is a still further object of the present invention to provide a novel red-light organic electroluminescent device improved in high color purity.

It is yet a further object of the present invention to provide a novel red-light organic electroluminescent device improved in high luminance.

It is yet a further object of the present invention to provide a novel red-light organic electroluminescent device improved in long durability.

The present invention provides a an organic electroluminescent device including: an anode; a cathode; at least one luminescent layer disposed between the anode and the cathode, and the at least one luminescent layer including at least a host material represented by a general formula (20) and at least a dopant represented by a general formula (10); at least an electron transport layer between the at least one luminescent layer and the cathode, and the at least electron transport layer including at least a compound represented by a general formula (30).

The above and other objects, features and advantages of the present invention will be apparent from the following descriptions.

### BRIEF DESCRIPTION OF THE DRAWINGS

Preferred embodiments according to the present invention will be described in detail with reference to the accompanying drawings.

FIG. 1 is a view of a novel organic EL device of the present invention.

FIG. 2 is a view of an evaluated result in examples 55 and 56 of the present invention.

FIG. 3 is a view of an evaluated result in an example 57 of the present invention and a comparative example 31.

### DETAILED DESCRIPTION OF THE PREFERRED EMBODIMENT

A first aspect of the present invention is an organic electroluminescent device including: an anode; a cathode; at least one luminescent layer disposed between the anode and the cathode, and the at least one luminescent layer including at least a host material represented by a general formula (20) and at least a dopant represented by a general formula (10); at least an electron transport layer between the at least one luminescent layer and the cathode, and the at least electron transport layer including at least a compound represented by a general formula (30),

wherein the general formula (10) is

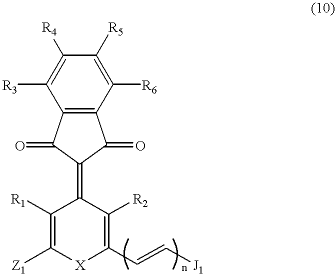

where each of R1˜R6 and Z1 is one of hydrogen atom, halogen atom, a substituted amino group, an unsubstituted amino group, a nitro group, a cyano group, a substituted alkyl group, an unsubstituted alkyl group, a substituted alkenyl group, an unsubstituted alkenyl group, a substituted cycloalkyl group, an unsubstituted cycloalkyl group, a substituted alkoxyl group, an unsubstituted alkoxyl group, a substituted aryl group, an unsubstituted aryl group, a substituted aromatic heterocyclic group, an unsubstituted aromatic heterocyclic group, a substituted aralkyl group, an unsubstituted aralkyl group, a substituted aryloxy group, and an unsubstituted aryloxy group, and X is any one of oxygen atom, sulfur atom and a chemically bonded nitrogen with G, where G is one of hydrogen atom and alkyl groups, “n” is 1 or 2, J1 is either a substituted 4-amino phenyl group or an unsubstituted 4-amino phenyl group, and the substituted and unsubstituted 4-amino phenyl groups are represented by the following general formula (10′),

wherein the general formula (20) is

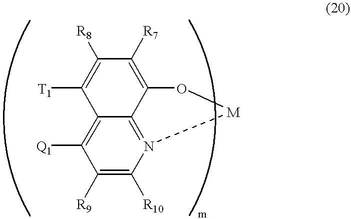

where M is aluminum atom or beryllium atom, and if M is aluminum atom, then “m” is 3, if M is beryllium atom, then “m” is 2, and each of R7˜R10, T1 and Q1 is one of hydrogen atom, halogen atom, a substituted cyano group, an unsubstituted cyano group, a nitro group, a substituted alkyl group, an unsubstituted alkyl group, a substituted alkoxyl group, an unsubstituted alkoxyl group, a substituted cycloalkyl group, an unsubstituted cycloalkyl group, a substituted aryl group, an unsubstituted aryl group, a substituted aryloxy group, an unsubstituted aryloxy group, a substituted aromatic heterocyclic group, and an unsubstituted aromatic heterocyclic group,

wherein the general formula (30) is

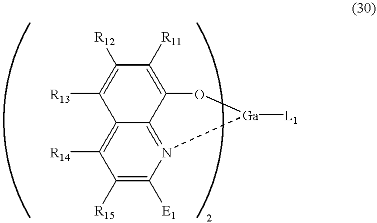

where each of R11˜R15 and E1 is one of hydrogen atom, halogen atom, a cyano group, a nitro group, a substituted alkyl group, an unsubstituted alkyl group, a substituted alkoxyl group, an unsubstituted alkoxyl group, a substituted cycloalkyl group, an unsubstituted cycloalkyl group, a substituted aryl group, an unsubstituted aryl group, a substituted aryloxy group, an unsubstituted aryloxy group, a substituted aromatic heterocyclic group, and an unsubstituted aromatic heterocyclic group, and L1 is one of halogen atom, a substituted alkyl group, an unsubstituted alkyl group, a substituted alkoxyl group, an unsubstituted alkoxyl group, a substituted aryl group, an unsubstituted aryl group, a substituted aryloxy group, and an unsubstituted aryloxy group, and

wherein the general formula (10′) is

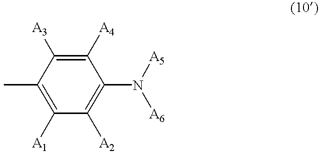

where each of A1˜A6 is one of hydrogen atom, halogen atom, a substituted amino group, an unsubstituted amino group, a nitro group, a cyano group, a substituted alkyl group, an unsubstituted alkyl group, a substituted alkoxyl group, a substituted aryl group, an unsubstituted aryl group, a substituted aryloxy group, an unsubstituted aryloxy group, a substituted aromatic heterocyclic group, and an unsubstituted aromatic heterocyclic group.

It is possible that adjacent substituted groups of Z1 and R1˜R6 may be in a form of a ring.

It is also possible that adjacent substituted groups of R7˜R10, T1 and Q1 may be in a form of a ring.

It is also possible that adjacent substituted groups of R11˜R15 and E1 may be in a form of a ring.

It is also possible that adjacent substituted groups of A1˜A6 may be in a form of a ring.

It is preferable that a thickness of the election transport layer is in the range of 0.2-1.8 times of a thickness of the luminescent layer.

It is possible to further include a hole transport layer disposed between the anode and the luminescent layer.

It is further possible that the hole transport layer includes an aromatic amine.

A second aspect of the present invention is an organic electroluminescent device including: an anode; a cathode; at least one luminescent layer disposed between the anode and the cathode, and the at least one luminescent layer including at least a host material represented by a general formula (21) and at least a dopant represented by a general formula (11); at least an electron transport layer between the at least one luminescent layer and the cathode, and the at least electron transport layer including at least a compound represented by a general formula (31),

wherein the general formula (11) is

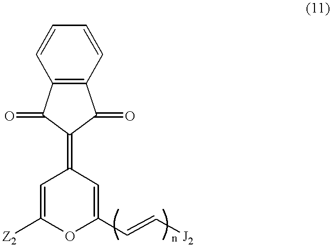

where Z2 is one of an alkyl group having a carbon number of not more than 4, a substituted cycloalkyl group, an unsubstituted cycloalkyl group, a substituted phenyl group, and an unsubstituted phenyl group, and “n” is 1 or 2, J2 is either a substituted 4-amino phenyl group or an unsubstituted 4-amino phenyl group, and the substituted and unsubstituted 4-amino phenyl groups are represented by the following general formula (11′),

wherein the general formula (21) is

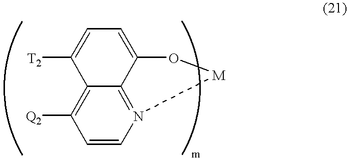

where M is aluminum atom or beryllium atom, and if M is aluminum atom, then “m” is 3, if M is beryllium atom, then “m” is 2, and each of T2 and Q2 is one of hydrogen atom, and an alkyl group having a carbon number of not more than 4,

wherein the general formula (31) is

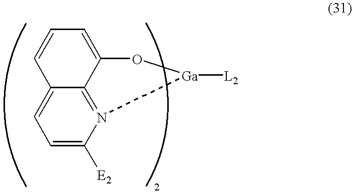

where E2 is one of hydrogen atom, and an alkyl group having a carbon number of not more than 4, and L2 is a halogen atom, a substituted phenoxyl group, an unsubstituted phenoxyl group, a substituted alpha-naphthyloxy group, an unsubstituted alpha-naphthyloxy group, a substituted beta-naphthyloxy group, an unsubstituted beta-naphthyloxy group, a substituted 2biphenyloxy group, an unsubstituted 2-biphenyloxy group, a substituted 3-biphenyloxy group, an unsubstituted 3-biphenyloxy group, a substituted 4-biphenyloxy group, an unsubstituted 4-biphenyloxy group, a substituted 1-anthryloxy group, an unsubstituted 1-anthryloxy group, a substituted 2-anthryloxy group, an unsubstituted 2-anthryloxy group, a substituted 9-anthryloxy group, an unsubstituted 9-anthryloxy group, a substituted 1-phenanthryl oxy group, an unsubstituted 1-phenanthryl group, a substituted 2phenanthryl oxy group, an unsubstituted 2-phenanthryl group, a substituted 4-phenanthryl oxy group, an unsubstituted 4-phenanthryl group, a substituted 3-phenanthryl oxy group, an unsubstituted 3-phenanthryl group, a substituted 9-phenanthryl oxy group, and an unsubstituted 9-phenanthryl group, and

wherein the general formula,(11′) is

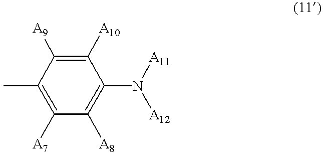

where each of A7˜A12 is one of hydrogen atom, halogen atom, a substituted amino group, an unsubstituted amino group, a nitro group, a cyano group, a substituted alkyl group, an unsubstituted alkyl group, a substituted alkoxyl group, a substituted aryl group, an unsubstituted aryl group, a substituted aryloxy group, an unsubstituted aryloxy group, a substituted aromatic heterocyclic group, and an unsubstituted aromatic heterocyclic group.

It is possible that adjacent substituted groups of A7˜A12 are in a form of a ring.

It is possible that a thickness of the electron transport layer is in the range of 0.2-1.8 times of a thickness of the luminescent layer

It is possible to further include a hole transport layer disposed between the anode and the luminescent layer. It is further possible that the hole transport layer includes an aromatic amine.

This second aspect of the present inventions has the same characteristics described above in connection with the first aspect of the present invention.

First Embodiment

A first embodiment according to the present invention will be described in detail. The first embodiment according to the present invention provides an organic electroluminescent device which includes: an anode; a cathode; at least one luminescent layer disposed between the anode and the cathodes and the at least one luminescent layer including at least a host material represented by a general formula (20) and at least a dopant represented by a general formula (10); at least an electron transport layer between the at least one luminescent layer and the cathode, and the at least electron transport layer including at least a compound represented by a general formula (30),

wherein the general formula (10) is

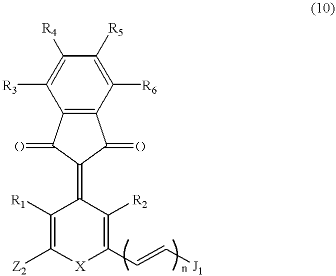

where each of R1˜R6 and Z1 is one of hydrogen atom, halogen atom, a substituted amino group, an unsubstituted amino group, a nitro group, a cyano group, a substituted alkyl group, an unsubstituted alkyl group, a substituted alkenyl group, an unsubstituted alkenyl group, a substituted cycloalkyl group, an unsubstituted cycloalkyl group, a substituted alkoxyl group, an unsubstituted alkoxyl group, a substituted aryl group, an unsubstituted aryl group, a substituted aromatic heterocyclic group, an unsubstituted aromatic heterocyclic group, a substituted aralkyl group, an unsubstituted aralkyl group, a substituted aryloxy group, and an unsubstituted aryloxy group, and X is any one of oxygen atom, sulfur atom and a chemically bonded nitrogen with G, where G is one of hydrogen atom and alkyl groups, “n” is 1 or 2, J1 is either a substituted 4-amino phenyl group or an unsubstituted 4-amino phenyl group, and the substituted and unsubstituted 4-amino phenyl groups are represented by the following general formula (10′),

wherein the general formula (20) is

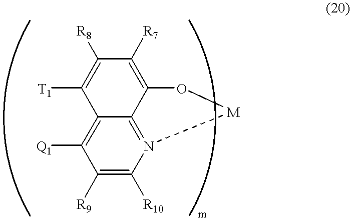

where M is aluminum atom or beryllium atom, and if M is aluminum atom, then “m” is 3, if M is beryllium atom, then “m” is 2, and each of R7˜R10, T1 and Q1 is one of hydrogen atom, halogen atom, a substituted cyano group, an unsubstituted cyano group, a nitro group, a substituted alkyl group, an unsubstituted alkyl group, a substituted alkoxyl group, an unsubstituted alkoxyl group, a substituted cycloalkyl group, an unsubstituted cycloalkyl group, a substituted aryl group, an unsubstituted aryl group, a substituted aryloxy group, an unsubstituted aryloxy group, a substituted aromatic heterocyclic group, and an unsubstituted aromatic heterocyclic group,

wherein the general formula (30) is

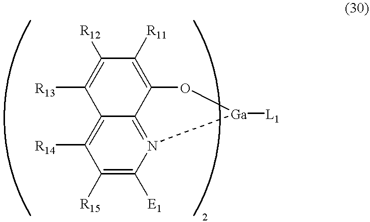

where each of R11˜R15 and E1 is one of hydrogen atom, halogen atom, a cyano group, a nitro group, a substituted alkyl group, an unsubstituted alkyl group, a substituted alkoxyl group, an unsubstituted alkoxyl group, a substituted cycloalkyl group, an unsubstituted cycloalkyl group, a substituted aryl group, an unsubstituted aryl group, a substituted aryloxy group, an unsubstituted aryloxy group, a substituted aromatic heterocyclic group, and an unsubstituted aromatic heterocyclic group, and L1 is one of halogen atom, a substituted alkyl group, an unsubstituted alkyl group, a substituted alkoxyl group, an unsubstituted alkoxyl group, a substituted aryl group, an unsubstituted aryl group, a substituted aryloxy group, and an unsubstituted aryloxy group, and

wherein the general formula (10′) is

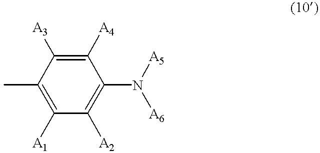

where each of A1˜A6 is one of hydrogen atom, halogen atom, a substituted amino group, an unsubstituted amino group, a nitro group, a cyano group, a substituted alkyl group, an unsubstituted alkyl group, a substituted alkoxyl group, a substituted aryl group, an unsubstituted aryl group, a substituted aryloxy group, an unsubstituted aryloxy group, a substituted aromatic heterocyclic group, and an unsubstituted aromatic heterocyclic group.

Adjacent substituted groups of Z1 and R1˜R6 may be in a form of a ring. Adjacent substituted groups of R7˜R10, T1 and Q1 may be in a form of a ring. Adjacent substituted groups of R11˜R15 and E1 may be in a form of a ring. Adjacent substituted groups of A1˜A6 may be in a form of a ring. A thickness of the electron transport layer is in the range of 0.2-1.8 times of a thickness of the luminescent layer.

Some examples of the substance represented by the general formula (10) are as follows, but the available dopant to the novel luminescent layer of the present invention is not limited to the following examples. The following general formulas (10-1) through (10-58) represent examples of the substance represented by the general formula (10).

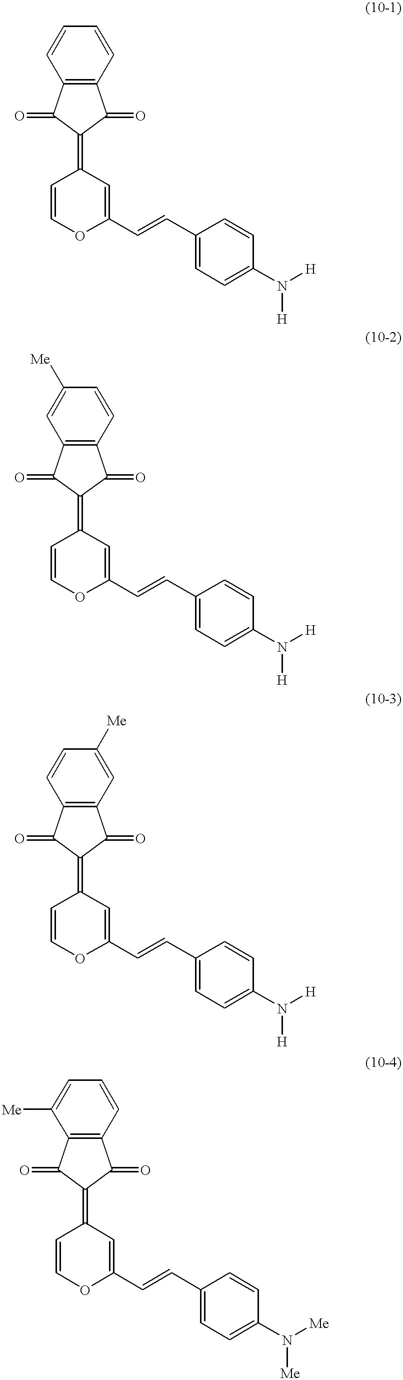

Some examples of the substance represented by the general formula (20) are as follows, but the available dopant to the novel luminescent layer of the present invention is not limited to the following examples. The following general formulas (20-1) through (20-34) represent examples of the substance represented by the general formula (20).

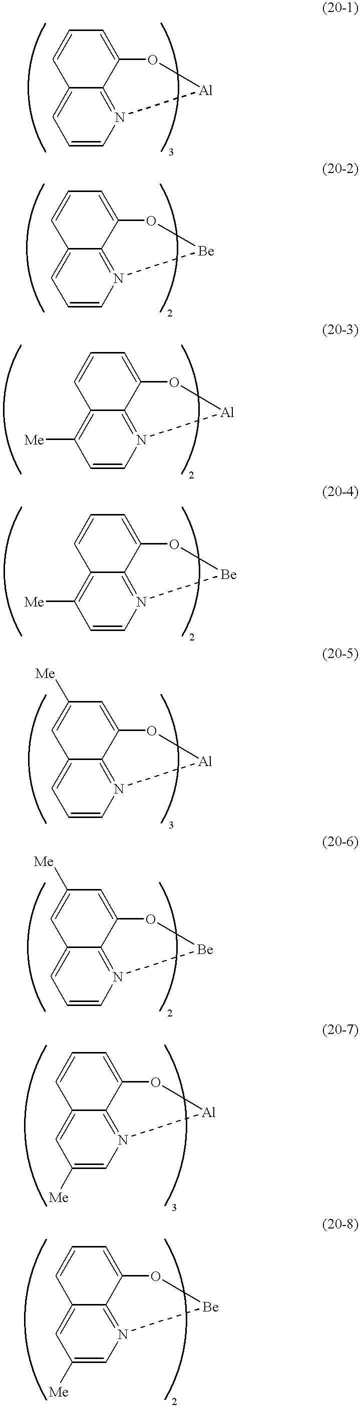

Some examples of the substance represented by the general formula (30) are as follows, but the available dopant to the novel luminescent layer of the present invention is not limited to the following examples. The following general formulas (30-1) through (30-55) represent examples of the substance represented by the general formula (30).

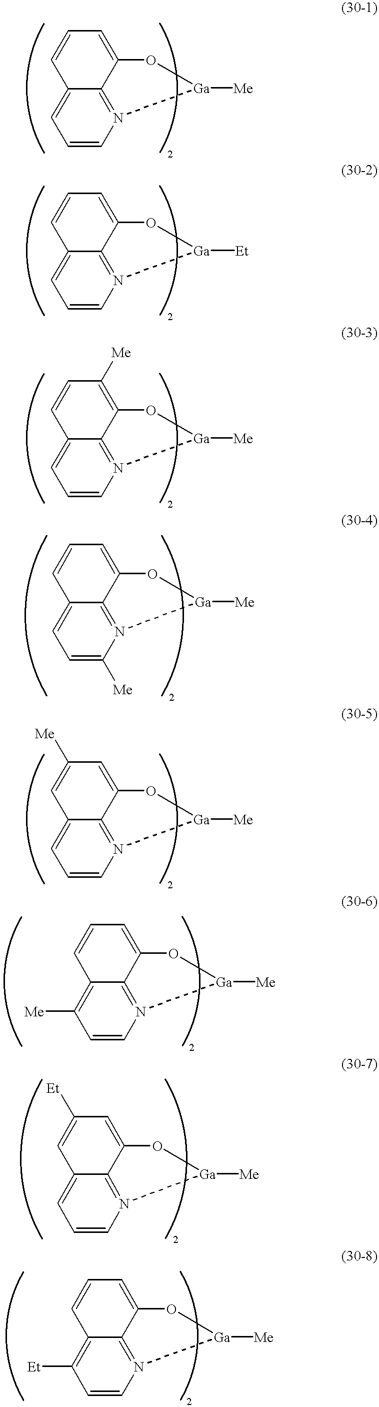

Second Embodiment

A second embodiment according to the present invention will be described in detail. The second embodiment according to the present invention provides an organic electroluminescent device including: an anode; a cathode; at least one luminescent layer disposed between the anode and the cathode, and the at least one luminescent layer including at least a host material represented by a general formula (21) and at least a dopant represented by a general formula (11); at least an electron transport layer between the at least one luminescent layer and the cathode, and the at least electron transport layer including at least a compound represented by a general formula (31),

wherein the general formula (11) is

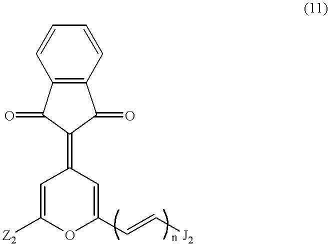

where Z2 is one of an alkyl group having a carbon number of not more than 4, a substituted cycloalkyl group, an unsubstituted cycloalkyl group, a substituted phenyl group, and an unsubstituted phenyl group, and “n” is 1 or 2, J2 is either a substituted 4-amino phenyl group or an unsubstituted 4-amino phenyl group, and the substituted and unsubstituted 4-amino phenyl groups are represented by the following general formula (11′),

wherein the general formula (21) is

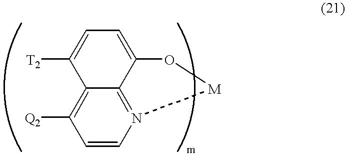

where M is aluminum atom or beryllium atom, and if M is aluminum atom, then “m” is 3, if M is beryllium atom, then “m” is 2, and each of T2 and Q2 is one of hydrogen atom, and an alkyl group having a carbon number of not more than 4,

wherein the general formula (31) is

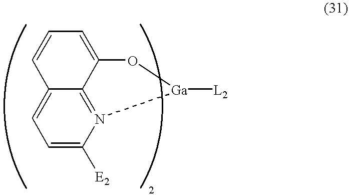

where E2 is one of hydrogen atom, and an alkyl group having a carbon number of not more than 4, and L2 is a halogen atom, a substituted phenoxyl group, an unsubstituted phenoxyl group, a substituted alpha-naphthyloxy group, an unsubstituted alpha-naphthyloxy group, a substituted beta-naphthyloxy group, an unsubstituted beta-naphthyloxy group, a substituted 2-biphenyloxy group, an unsubstituted 2-biphenyloxy group, a substituted 3-biphenyloxy group, an unsubstituted 3-biphenyloxy group, a substituted 4-biphenyloxy group, an unsubstituted 4-biphenyloxy group, a substituted 1-anthryloxy group, an unsubstituted 1-anthryloxy group, a substituted 2-anthryloxy group, an unsubstituted 2-anthryloxy group, a substituted 9-anthryloxy group, an unsubstituted 9-anthryloxy group, a substituted 1-phenanthryl oxy group, an unsubstituted 1-phenanthryl group, a substituted 2-phenanthryl oxy group, an unsubstituted 2-phenanthryl group, a substituted 4-phenanthryl oxy group, an unsubstituted 4-phenanthryl group, a substituted 3-phenanthryl oxy group, an unsubstituted 3-phenanthryl group, a substituted 9-phenanthryl oxy group, and an unsubstituted 9-phenanthryl group, and

wherein the general formula (11′) is

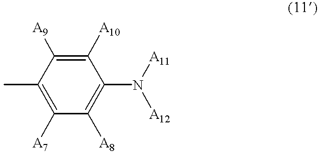

where each of A7˜A12 is one of hydrogen atom, halogen atom, a substituted amino group, an unsubstituted amino group, a nitro group, a cyano group, a substituted alkyl group, an unsubstituted alkyl group, a substituted alkoxyl group, a substituted aryl group, an unsubstituted aryl group, a substituted aryloxy group, an unsubstituted aryloxy group, a substituted aromatic heterocyclic group, and an unsubstituted aromatic heterocyclic group. Adjacent substituted groups of A7˜A12 are in a form of a ring. A thickness of the electron transport layer is in the range of 0.2-1.8 times of a thickness of the luminescent layer.

Some examples of the substance represented by the general formula (11) are the above-described general formulas (10-6), (10-21), (10-8), (10-22), (10-23), (10-24), (10-25), (10-26), (10-29), (10-30), (10-31), (10-32), (10-33), (10-34), (10-35), (10-36), (10-37), (10-38), (10-39), (10-40), (10-41), (10-42), (10-43), (10-44), (10-45), (10-46), (10-47), (10-48), (10-49), (10-50), (10-51), (10-52), (10-53), (10-54), (10-55), (10-56), (10-57), and (10-58). The substance represented by the general formula (11) is not limited to the above examples.

Some examples of the substance represented by the general formula (21) are the above-described general formulas (20-1), (20-2), (20-3), (20-3), (20-4), (20-9), (20-10), (20-11), (20-12), (20-13), and (20-14). The substance represented by the general formula (31) is not limited to the above examples.

Some examples of the substance represented by the general formula (31) are the above-described general formulas (30-15), (30-17), (30-31), (30-37), (30-37), (30-38), (30-38), (30-39), (30-40), (30-41), (30-41), (30-42), (30-44), (30-45), (30-47), (30-48), (30-49), (30-51), (30-51), and (30-52).

In the above first and second embodiments, it is optionally possible that the hole transport layer is provided between the luminescent layer and the anode. One example of the preferable materials for the hole transport layer is aromatic amines. The aromatic amines for the hole transport layer are not limited, but it is preferable that the aromatic amines have small ionization potential, large hole mobility, and high stability as well as impurity as trap is unlikely generated. The following TPAC, TPD, alpha-NPD, TPTE, and PVK are some preferable examples, but the available compounds are not limited thereto. A high glass transition temperature is preferable because this makes it easy to prepare an organic EL device, which is superior in durability. The available compounds may be used solely or in mixture.

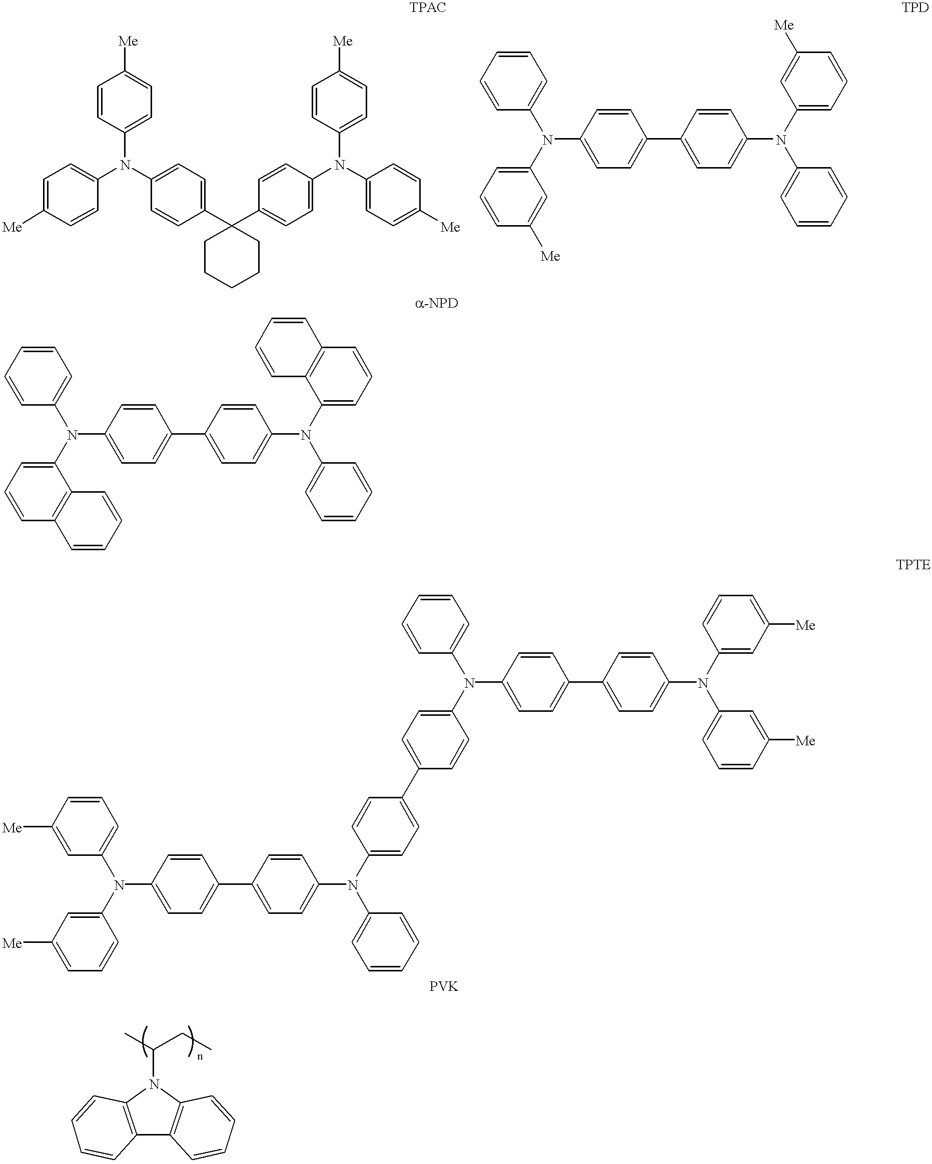

The above novel organic electroluminescence devices of the first and second embodiments are free in structure and material for the other parts than the luminescent layers and the electron transport layer and optionally the hole transport layer A supporting substrate, an anode and a cathode have no limitations.

In accordance with the first embodiment, the luminescent layer may include the host material represented by the general formula (20) the dopant represented by the general formula (10), and optionally further include one or more other compounds. The electron transport layer (30) may include the compound represented by the general formula (30), and optionally further include one or more other compounds.

In accordance with the first embodiment, the luminescent layer may include the host material represented by the general formula (21) the dopant represented by the general formula (11), and optionally further include one or more other compounds. The electron transport layer may include the compound represented by the general formula (31), and optionally further include one or more other compounds.

In order to increase the thermal stability of the layers, it is effective to mix a polymer as matrix material.

It is optionally possible to further interpose one or more buffer layers between adjacent layers. For example, a hole injection layer may preferably be provided between the anode and the hole transport layer in order to promote hole injection from the anode to the hole transport layer. A hole block layer may preferably be provided between the luminescent layer and the electron transport layer in order to prevent hole leakage from the luminescent layer to the electron transport layer.

A material for the hole transport layer is not limited, but it is preferable in promoting the hole injection that an ionization potential of the material of the hole injection layer is between a work function of the anode and an ionization potential of the martial of the hole transport layer. It is also preferable that the materials for the hole transport layer and the hole injection layer are large in hole mobility and high in electrochemical stability as well as are unlikely to allow formation of impurity as traps. For example, copper phthalocyanine, the following OA-3, m-MTDATA, 2-TNATA are available.

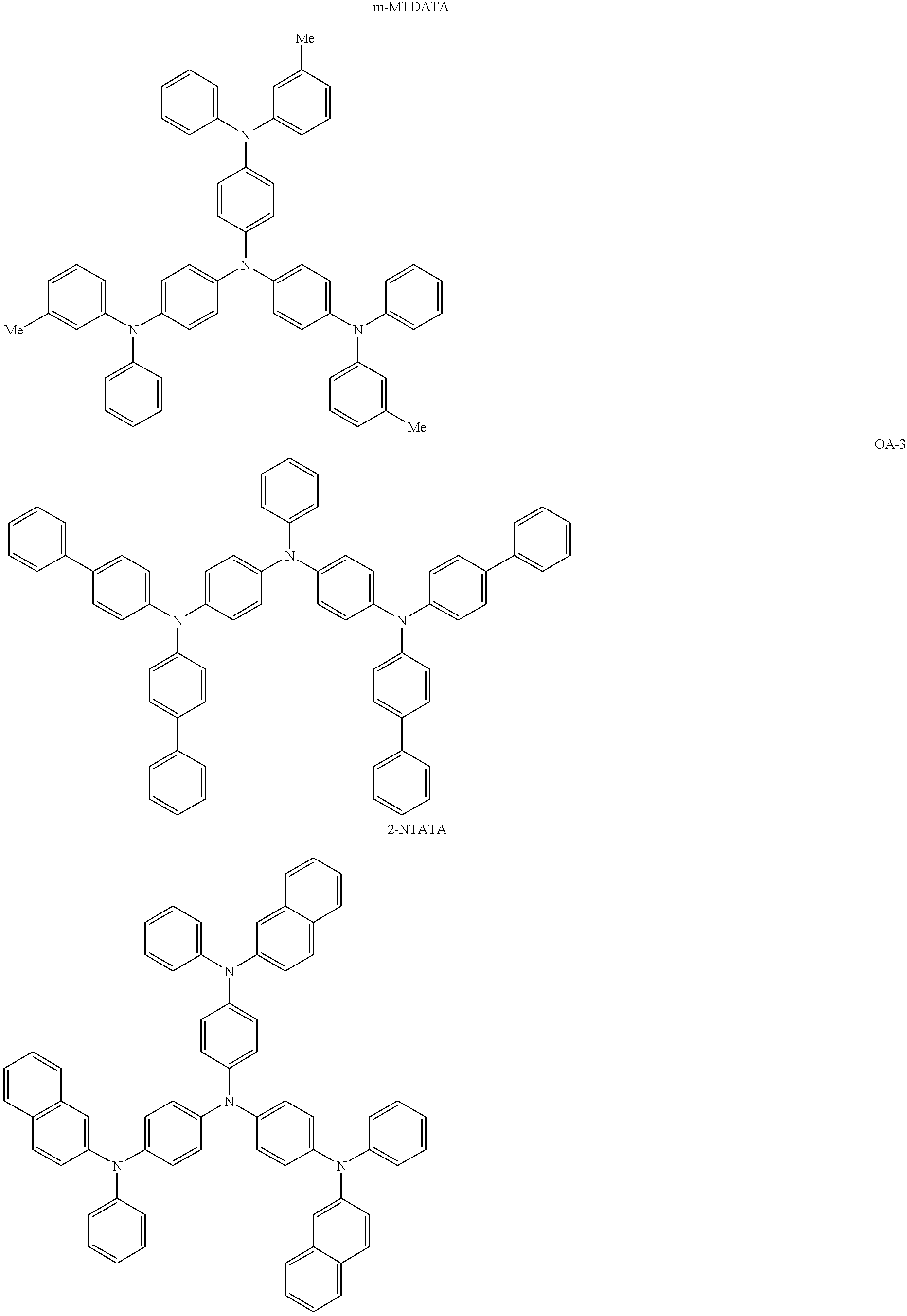

It is also preferable that the material for the hole block layer is large in potential barrier to hole and high in electrochemical stability as well as are unlikely to allow formation of impurity as traps. For example, the following 2-(4-biphenyl)-5-(4-t-buthyl phenyl)- 1,3,4-oxadiazole (PBD), 2,9-dimethyl-4,7-diphenyl-1,10-phenanthroline (VP) are available.

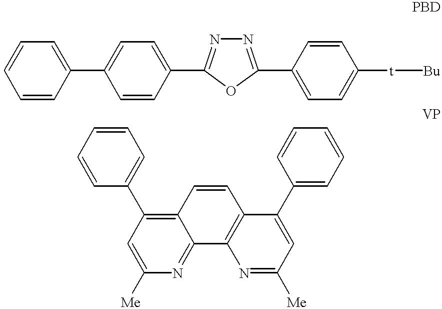

The organic electroluminescence device may have any one of various layered structures which should not be limited to the following four examples.

A first example of the layered structure of the organic electroluminescence device is that an anode, a hole transport layer in contact with the anode, a luminescent layer in contact with the hole transport layer, an electron transport layer in contact with the luminescent layer, and a cathode in contact with the electron transport layer.

A second example of the layered structure of the organic electroluminescence device is that an anode, a hole injection layer in contact with the anode, a bole transport layer in contact with the hole injection layer, a luminescent layer in contact with the hole transport layer, an electron transport layer in contact with the luminescent layer, and a cathode in contact with the electron transport layer.

A third example of the Layered structure of the organic electroluminescence device is that an anode, a hole transport layer in contact with the anode, a luminescent layer in contact with the hole transport layer, a hole block layer in3 contact with the luminescent layer, an electron transport layer in contact with the hole block layer, and a cathode in contact with the electron transport layer.

A fourth example of the layered structure of the organic electroluminescence device is that an anode, a hole injection layer in contact with the anode, a hole transport layer in contact with the hole injection layer, a luminescent layer in contact with the hole transport layer, a hole block layer in contact with the luminescent layer, an electron transport layer in contact with the hole block layer, and a cathode in contact with the electron transport layer.

Either the anode side or the cathode side may preferably be fixed to the supporting substrate.

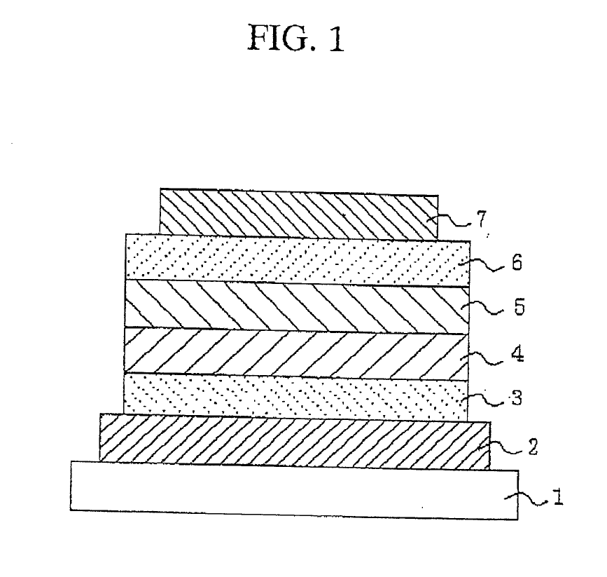

FIG. 1 shows the organic electroluminescence device having the structure of the above second example, wherein the anode side is fixed to the supporting substrate. An anode 2 is provided on a supporting substrate 1. A hole injection layer 3 is provided on the anode 2. A hole transport layer 4 is provided on the hole injection layer 3. A luminescent layer 5 is provided on the hole transport layer 4. An electron transport layer 6 is provided on the luminescent layer 5. A cathode 7 is provided on the electron transport layer 6.

Known materials for the supporting substrate 1, the anode 2, the hole injection layer 3, and the cathode 7 may be available. For the supporting substrate, there are available glass materials, plastic materials, quartz, metals in the form of a plate, a sheet or a film. Particularly, highly transparent materials, for example, transparent glasses, transparent plastics such as polyester, polymethacrylate and polycarbonate, and quartz are preferable.

For the anode material there are available metals, alloys, electrically conductive compounds and mixtures thereof, each of which has a large work functions. For example, transparent or semi-transparent dielectric materials such as Au, CuI, ITO, SnO₂, and ZnO.

For the cathode material, there are available metals, alloys, electrically conductive compounds and mixtures thereof, each of which has a small work functions. For example, sodium, magnesium, silver, aluminum, lithium, indium, rear earth metals, and alloys thereof.

It is preferable that at least one of the anode and the cathode is transparent or semi-transparent for allowing an emission of the light without substantive loss.

Alternatively, the supporting substrate 1 is fixed with the cathode 7. In this case, the cathode 7 is provided on the supporting substrate 1. The electron transport layer 6 is provided on the cathode 7. The luminescence layer 5 is provided on the electron transport layer 6. The hole transport layer 4 is provided on the luminescence layer 5. The hole injection layer 3 is provided on the hole transport layer 4. The anode 2 is provided on the hole injection layer 3.

### Example 1

An indium tin oxide (ITO) was deposited by a sputtering method on a glass substrate having a thickness of 0.7 millimeters to form an ITO film having a sheet resistance of 15 ohms/square. The ITO film is then patterned by a selective etching process to form a stripe shaped TIO film. This substrate was subjected to a first ultrasonic wave cleaning process with a neutral detergent and subsequently a second ultrasonic wave cleaning process with isopropyl alcohol. The substrate was dried and then heated to 105° C. for ultraviolet-ozone cleaning at this temperature for 10 minutes.

The substrate was quickly held on a substrate holder in a vacuum chamber of a vacuum evaporation system wherein the vacuum chamber had already been set with evaporation source boats, which respectively contain 100 mg of 2-TNATA for the hole injection layer, 100 mg of alpha-NPD for the hole transport layer, 200 mg of the compound represented by the above general formula (20-1) for the host material of the luminescence layer, 50 mg of the compound represented by the above general formula (10-6) for the dopant of the luminescence layer, 100 nag of the compound represented by the above general formula (30-1.5) for the electron transport layer, 1000 mg of aluminum for the cathode, 100 mg of lithium for the cathode. The boats fox containing the organic materials, for example, 2-TNATA, alpha-NPD, the compounds represented by the general formulas (20-1), (10-6) and (30-15) are made of molybdenum. The boats for containing aluminum and lithium are made of tungsten.

The chamber was vacuumed, After a pressure in the vacuum chamber reached in the order of 1E-5 Pa, the evaporation sources of 2-TNATA and alpha-NPD were sequentially heated, go that a hole injection layer of 2-TNATA having a thickness of 25 nanometers was formed on the ITO film, and further a hole transport layer of alpha-NPD having a thickness of 25 nanometers was formed on the hole injection layer. Thereafter, the boats containing the compounds of the general formulas (20-1) and (10-6) were concurrently heated to deposit those compounds to form a luminescent layer on the hole transport layer, wherein a ratio of the dopant to the host was 1.1 percent by weight. A total thickness was 50 nanometers.

Further, the boat containing the compound of the general formula (30-15) was heated to deposit this compound to form an electron transport layer having a thickness of 50 nanometers on the luminescent layer. The tungsten boats containing aluminum and lithium were concurrently heated to deposit an alloy of aluminum and lithium thereby forming a cathode on the electron transport layer. A deposition rate of aluminum was 1 nanometers/second, whilst a deposition rate of lithium was set so that a ratio of lithium to aluminum was 0.1 percent by weight. A total thickness of the cathode was 200 nanometers. After the heating to the lithium was discontinued, the heating to the aluminum is continued, so that a lithium-containing layer of 100 nanometers in thickness was formed in the cathode and adjacent to the electron transport layer.

In the above sequential processes, two kinds masks were used for both the organic layers and the cathode layer, to form 10 of luminescent pixels having a square of 2 mm by 2 mm. The mask for the organic layers was changed to the other mask for the cathode layer with keeping the vacuum. Namely, the sequential processes were carried out with keeping the vacuum, thereby forming the organic electroluminescence device. The organic electroluminescence device was then carried to a glove box with a dried nitrogen atmosphere without exposing the device to an air, and then the box was sealed with a glass cap and an adhesive agent of ultraviolet ray thermosetting type.

### Examples 2-54

The organic electroluminescence devices were obtained in the same processes, the same materials, the same layers thicknesses and the same deposition processes and the same sealing processes as Example 1 except for the dopant, the host and doping concentration as well as the material of the electron transport layer.

Maximum luminance and chromaticity coordinate of each of the organic electroluminescence devices of Examples 1-54 were measured by use of luminance meter and x-y chromaticity coordinate, during the step-by-step increase by 1 V of an applied voltage level from 0 V.

The following tables 1 and 2 show the dopant, the host and the doping concentration in percent by weight of the luminescence layer, the material for the electron transport layer, the maximum luminance (cd/m²) and the chromaticity coordinate (x, y) of the organic electroluminescence devices of Examples 1-54. “Ex” represents the example number. “EL” represents the electroluminescence layer. “Dope” represents the dopant. “Host” represents the host material. “DC” represents the dopant concentration. “ETL” represents the electron transport layer, “ML” represents the maximum luminance (cd/m²) “Chromat” represents the chromaticity coordinate (x, y).

TABLE 1

| | “EL” | | | | | |
|---|---|---|---|---|---|---|
| “Ex” | “Dope” | “Host” | “DC” | “ETL” | “ML” | “Chromat” |
| 1 | (10-6) | (20-1) | 1.1 | (30-15) | 31300 | (0.62, 0.38) |
| 2 | (10-6) | (20-1) | 1.1 | (30-17) | 31000 | (0.62, 0.38) |
| 3 | (10-6) | (20-1) | 1.1 | (30-31) | 30200 | (0.62, 0.38) |
| 4 | (10-6) | (20-1) | 1.1 | (30-37) | 29400 | (0.62, 0.38) |
| 5 | (10-6) | (20-3) | 1.1 | (30-38) | 30100 | (0.62, 0.38) |
| 6 | (10-6) | (20-15) | 1.1 | (30-31) | 26700 | (0.62, 0.38) |
| 7 | (10-6) | (20-2) | 1.1 | (30-17) | 30200 | (0.62, 0.38) |
| 8 | (10-13) | (20-1) | 0.8 | (30-17) | 28500 | (0.62, 0.38) |
| 9 | (10-13) | (20-1) | 0.8 | (30-37) | 29000 | (0.62, 0.38) |
| 10 | (10-13) | (20-1) | 0.8 | (30-40) | 29100 | (0.62, 0.38) |
| 11 | (10-13) | (20-1) | 0.8 | (30-44) | 27600 | (0.62, 0.38) |
| 12 | (10-13) | (20-3) | 0.8 | (30-40) | 28800 | (0.62, 0.38) |
| 13 | (10-14) | (20-1) | 1.0 | (30-17) | 28000 | (0.62, 0.38) |
| 14 | (10-14) | (20-3) | 1.0 | (30-17) | 27600 | (0.62, 0.38) |
| 15 | (10-14) | (20-3) | 1.0 | (30-25) | 24000 | (0.62, 0.37) |
| 16 | (10-17) | (20-1) | 1.0 | (30-37) | 25200 | (0.62, 0.38) |
| 17 | (10-17) | (20-2) | 1.0 | (30-40) | 25200 | (0.62, 0.37) |
| 18 | (10-20) | (20-1) | 1.0 | (30-38) | 27800 | (0.62, 0.38) |
| 19 | (10-20) | (20-1) | 1.0 | (30-44) | 30300 | (0.62, 0.38) |
| 20 | (10-20) | (20-3) | 1.0 | (30-40) | 30100 | (0.62, 0.38) |
| 21 | (10-22) | (20-1) | 0.8 | (30-37) | 35400 | (0.62, 0.38) |
| 22 | (10-22) | (20-1) | 0.8 | (30-49) | 37600 | (0.62, 0.38) |
| 23 | (10-22) | (20-9) | 0.8 | (30-38) | 36900 | (0.62, 0.38) |
| 24 | (10-22) | (20-3) | 0.8 | (30-38) | 35500 | (0.62, 0.38) |
| 25 | (10-22) | (20-2) | 0.8 | (30-31) | 35600 | (0.62, 0.38) |
| 26 | (10-23) | (20-1) | 1.0 | (30-37) | 38200 | (0.62, 0.38) |
| 27 | (10-23) | (20-1) | 1.0 | (30-38) | 38400 | (0.62, 0.38) |

TABLE 2

| | “EL” | | | | | |
|---|---|---|---|---|---|---|
| “Ex” | “Dope” | “Host” | “DC” | “ETL” | “ML” | “Chromat” |
| 28 | (10-23) | (20-3) | 1.0 | (30-38) | 37900 | (0.62, 0.38) |
| 29 | (10-23) | (20-17) | 1.0 | (30-40) | 32900 | (0.62, 0.38) |
| 30 | (10-25) | (20-1) | 1.0 | (30-31) | 34600 | (0.62, 0.38) |
| 31 | (10-25) | (20-1) | 1.0 | (30-44) | 33200 | (0.62, 0 38) |
| 32 | (10-25) | (20-1) | 1.0 | (30-48) | 37100 | (0.62, 0.38) |
| 33 | (10-25) | (20-1) | 1.0 | (30-52) | 32700 | (0.62, 0.38) |
| 34 | (10-25) | (20-1) | 1.0 | (30-24) | 31300 | (0.62, 0.38) |
| 35 | (10-25) | (20-33) | 1.0 | (30-37) | 32400 | (0.62, 0.38) |
| 36 | (10-25) | (20-2) | 1.0 | (30-38) | 36700 | (0.62, 0.38) |
| 37 | (10-28) | (20-1) | 0.8 | (30-40) | 29600 | (0.62, 0.38) |
| 38 | (10-28) | (20-3) | 0.8 | (30-44) | 29900 | (0.62, 0.38) |
| 39 | (10-28) | (20-33) | 0.8 | (30-31) | 26700 | (0.62, 0.38) |
| 40 | (10-28) | (20-2) | 0.8 | (30-37) | 27300 | (0.62, 0.38) |
| 41 | (10-32) | (20-1) | 0.9 | (30-38) | 36200 | (0.62, 0.38) |
| 42 | (10-32) | (20-1) | 0.9 | (30-39) | 36600 | (0.62, 0.38) |
| 43 | (10-32) | (20-3) | 0.9 | (30-41) | 35900 | (0.62, 0.38) |
| 44 | (10-36) | (20-1) | 0.9 | (30-44) | 27300 | (0.62, 0.37) |
| 45 | (10-36) | (20-33) | 0.9 | (30-31) | 28500 | (0.62, 0.38) |
| 46 | (10-36) | (20-33) | 0.9 | (30-37) | 23600 | (0.62, 0.37) |
| 47 | (10-36) | (20-2) | 0.9 | (30-40) | 24900 | (0.62, 0.38) |
| 48 | (10-40) | (20-1) | 1.0 | (30-37) | 34000 | (0.62, 0.38) |
| 49 | (10-47) | (20-1) | 0.8 | (30-47) | 31200 | (0.62, 0.38) |
| 50 | (10-50) | (20-1) | 0.8 | (30-40) | 33400 | (0.62, 0.38) |
| 51 | (10-50) | (20-3) | 0.8 | (30-44) | 32200 | (0.62, 0.38) |
| 52 | (10-53) | (20-1) | 0.8 | (30-37) | 30600 | (0.62, 0.38) |
| 53 | (10-53) | (20-1) | 0.8 | (30-42) | 31400 | (0.62, 0.38) |
| 54 | (10-53) | (20-33) | 0.8 | (30-50) | 31800 | (0.62, 0.38) |

### Comparative Examples 1-30

The organic electroluminescence devices were obtained in the same processes, the same materials, the same layers thicknesses and the same deposition processes and the same sealing processes as Example 1 except for the dopant, the host and doping concentration as well as the material of the electron transport layer.

Maximum luminance and chromaticity coordinate of each of the organic electroluminescence devices of Comparative Examples 1-30 were measured by use of luminance meter and x-y chromaticity coordinate, during the step-by-step increase by 1 V of an applied voltage level from 0 V.

The following table 3 shows the dopant, the host and the doping concentration in percent by weight of the luminescence layer, the material for the electron transport layer, the maximum luminance (cd/m²) and the chromaticity coordinate (x, y) of the organic electroluminescence devices of Comparative Examples 1-30. “Ex” represents the example number. “EL” represents the electroluminescence layer. “Dope” represents the dopant. “Host” represents the host material. “DC” represents the dopant concentration. “ETL” represents the electron transport layer. “ML” represents the maximum luminance (cd/m²). “Chromat” represents the chromaticity coordinate (x, y). “A” represents the compound represented by the following general formula (comparative compound A), “B” represents the compound represented by the following general formula (comparative compound B). “C” represents the compound represented by the following general formula (comparative compound C). “D” represents the compound represented by the following general formula (comparative compound D). “E” represents the compound represented by the following general formula (comparative compound E).

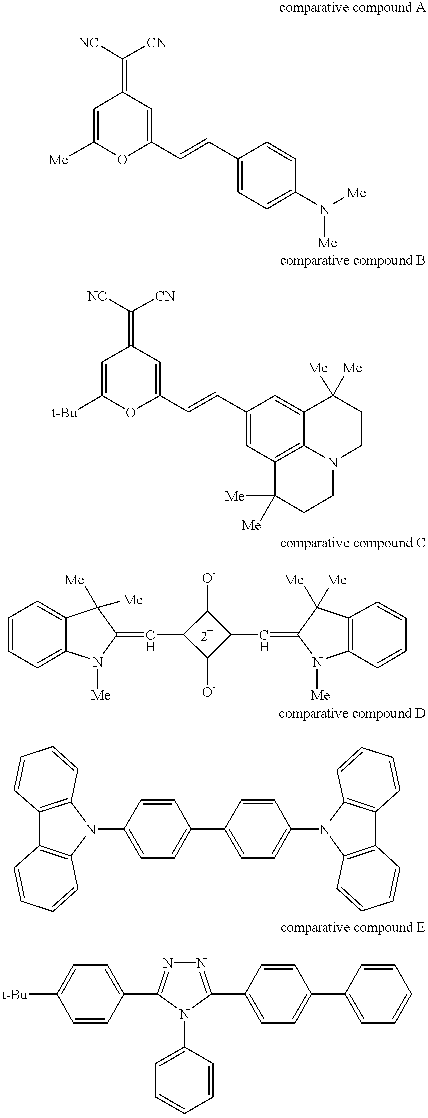

TABLE 3

| | “EL” | | | | | |
|---|---|---|---|---|---|---|
| “Ex” | “Dope” | “Host” | “DC” | “ETL” | “ML” | “Chromat” |
| 1 | A | (20-1) | 1.1 | (30-37) | 20900 | (0.61, 0.40) |
| 2 | A | (20-1) | 1.1 | (30-40) | 19100 | (0.62, 0.38) |
| 3 | A | (20-1) | 1.1 | Alq3 | 19600 | (0.60, 0.40) |
| 4 | A | (20-3) | 1.1 | (30-37) | 18100 | (0.62, 0.38) |
| 5 | A | (20-2) | 1.1 | (30-17) | 18700 | (0.62, 0.38) |
| 6 | B | (20-1) | 1.1 | (30-37) | 27800 | (0.62, 0.38) |
| 7 | B | (20-1) | 1.1 | (30-40) | 27400 | (0.62, 0.38) |
| 8 | B | (20-1) | 1.1 | Alq3 | 27200 | (0.60, 0.39) |
| 9 | B | (20-3) | 1.1 | (30-37) | 26500 | (0.62, 0.38) |
| 10 | B | (20-2) | 1.1 | (30-17) | 28300 | (0.62, 0.38) |
| 11 | C | (20-1) | 0.8 | (30-37) | 6500 | (0.62, 0.38) |
| 12 | C | (20-1) | 0.8 | (30-40) | 5600 | (0.62, 0.38) |
| 13 | C | (20-3) | 0.8 | (30-37) | 3900 | (0.62, 0.37) |
| 14 | C | (20-2) | 0.8 | (30-17) | 4400 | (0.62, 0.38) |
| 15 | (10-6) | D | 1.1 | (30-37) | 6600 | (0.58, 0.37) |
| 16 | (10-13) | D | 0.8 | (30-40) | 7900 | (0.58, 0.37) |
| 17 | (10-25) | D | 1.0 | (30-37) | 7400 | (0.57, 0.37) |
| 18 | (10-36) | D | 0.9 | (30-17) | 5200 | (0.58, 0.38) |
| 19 | (10-6) | α-NPD | 1.1 | (30-37) | 3100 | (0.57, 0.37) |
| 20 | (10-13) | α-NPD | 0.8 | (30-40) | 5200 | (0.57, 0.38) |
| 21 | (10-25) | α-NPD | 1.0 | (30-37) | 4400 | (0.58, 0.37) |
| 22 | (10-36) | α-NPD | 0.9 | (30-17) | 5600 | (0.57, 0.37) |
| 23 | (10-6) | (20-1) | 1.1 | Alq3 | 22000 | (0.61, 0.38) |
| 24 | (10-13) | (20-1) | 0.8 | Alq3 | 21400 | (0.61, 0.39) |
| 25 | (10-21) | (20-1) | 0.8 | (20-2) | 20900 | (0.62, 0.38) |
| 26 | (10-22) | (20-3) | 0.8 | E | 18400 | (0.62, 0.38) |
| 27 | (10-22) | (20-3) | 0.8 | Alq3 | 20700 | (0.62, 0.38) |
| 28 | (10-25) | (20-3) | 1.0 | Alq3 | 19200 | (0.62, 0.38) |
| 29 | (10-25) | (20-33) | 1.0 | E | 17700 | (0.62, 0.38) |
| 30 | (10-36) | (20-2) | 0.9 | Alq3 | 20300 | (0.61, 0.39) |

The above tables 1-3 show the follows. If the luminescent layer includes the host material represented by the general formula (20) doped with the dopant represented by the general formula (10), and the electron transport layer includes the compound represented by the general formula (30), then the organic electroluminescence device exhibited high performances, for example, the desired red-light emission at very high color purity and luminance levels.

If the luminescent layer includes the host material represented by the general formula (20) doped with the dopant represented by the general formula (10), and the electron transport layer includes the compound represented by the general formula (30), then the organic electroluminescence device exhibited further high performances, for example, the desired red-light emission at further higher color purity and luminance levels.

In Examples 21-28, 32, 36, and 41-43, the color purity was maintained at (0.62, 0.38), and the maximum luminance was 35,000 cd/m². The dopant represented by the general formula (10) performs the desired highly insensitive luminance. The combinations of the dopant represented by the general formula (10) and the host material represented by the general formula (20) for the luminescence layer allows hole and electron motions in balance in this layer. Further, the electron transport layer comprising the compound represented by the general formula (30) shows high performances of preventing the leakage of holes and allowing electron injection and motion. The above organic electroluminescence device is easily applicable to a simple matrix driving color organic electroluminescence display with about 240 scanning lines.

### Example 55

The same materials as in Example 27 of the organic electroluminescence device were used, provided that the thickness of the luminescence layer is fixed at 50 nanometers, and the thickness of the electron transport layer varies. Namely, the dopant was the compound represented by the general formula (10-23). The host material was the compound represented by the general formula (20-1). The doping concentration was 1.0 percent by weight The electron transport layer comprises the compound represented by the general formula (30-38), and the thickness of the electron transport layer varies. The performances of the organic electroluminescence devices were measured.

### Example56

The same materials as in Example 27 of the organic electroluminescence device were used, provided that the thickness of the luminescence layer is fixed at 70 nanometers, and the thickness of the electron transport layer varies, Namely, the dopant was the compound represented by the general formula (10-23). The host material was the compound represented by the general formula (20-1), The doping concentration was 1.0 percent by weight. The electron transport layer comprises the compound represented by the general formula (30-38), and the thickness of the electron transport layer varies. The performances of the organic electroluminescence devices were measured.

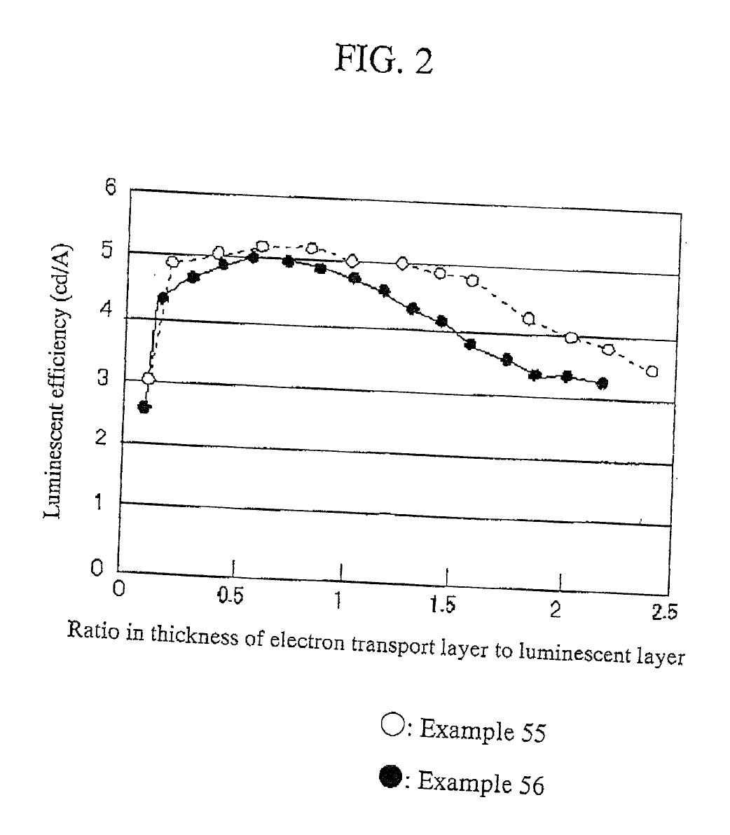

FIG. 2 is a diagram of variation in luminescence efficiency over ratio in thickness of electron transport layer to luminescence layer for the organic electroluminescence devices in Examples 55 and 56. The luminescence efficiency is at the luminance of 1000 cd/m².

FIG. 2 shows that as the ratio in thickness of electron transport layer to luminescence layer is in the range of 0.2 to 0.8, the organic electroluminescence devices exhibits the high luminescence efficiencies, Injections of electrons and holes into the luminescence layer are kept in good balance, whereby an electron-hole re-combination region widely extends in the luminescence layer. The maximum luminescence efficiency was about 5 cd/A.

In addition, the same materials as in each of Examples 21-27, 28, 32, 36 and 41-43 of the organic electroluminescence device were used, provided that the thickness of the luminescence layer is fixed, and the thickness of the electron transport layer varies. The performances of the organic electroluminescence devices were measured. It was confirmed that as the ratio in thickness of electron transport layer to luminescence layer is in the range of 0.2 to 0.8, the organic electroluminescence devices exhibits the high luminescence efficiencies. Injections of electrons and holes into the luminescence layer are kept in good balance, whereby an electron-hole recombination region widely extends in the luminescence layer. The maximum luminescence efficiency was about 5 cd/A.

### Example 27

The organic electroluminescence device of Example 27 was evaluated in durability at room temperature, wherein an injection current was adjusted to obtain an initial luminance of 200 cd/m², so that the variation in relative luminance over driving time was measured by a constant current driving.

### Comparative Example 31

The organic electroluminescence device of Comparative Example 8 was evaluated in durability at room temperature, wherein an injection current was adjusted to obtain an initial luminance of 200 cd/m², so that the variation in relative luminance over driving time was measured by a constant current driving.

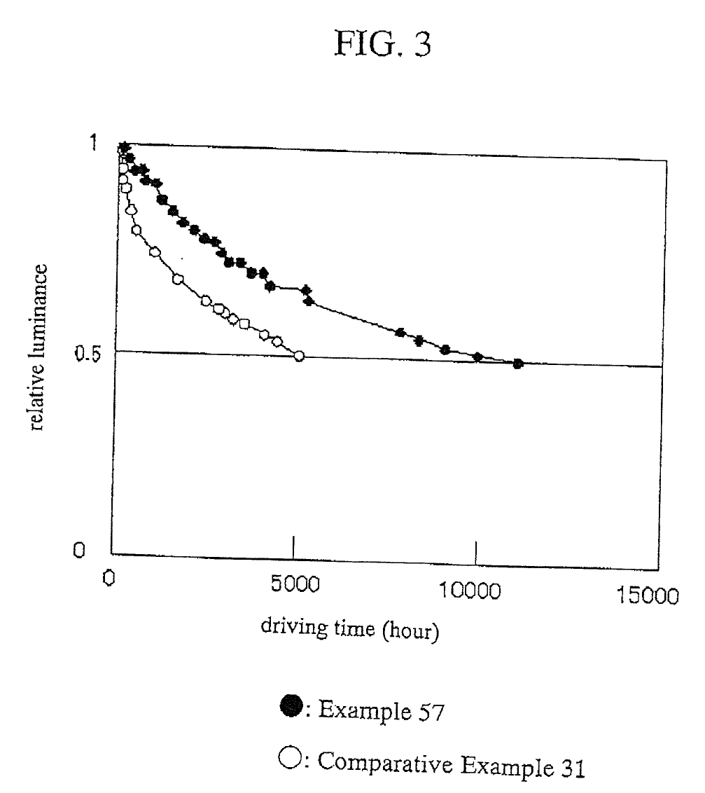

FIG. 3 is a diagram of variation in relative luminance over driving time for the organic electroluminescence devices of Example 57 and Comparative Example 8. FIG. 3 shows that the organic electroluminescence device of Example 57 is superior in durability than the organic electroluminescence device of Comparative Example 8. The durability of the organic electroluminescence device of Example 57 exceeded 10000 hours.

In addition, the organic electroluminescence devices of Examples 21-26; 28, 32, 36 and 41-43 were also evaluated in durability at room temperature, wherein an injection current was adjusted to obtain an initial luminance of 200 cd/m², so that the variation in relative luminance over driving time was measured by a constant current driving. It was confirmed that the durability of the organic electroluminescence devices of Examples 21-26, 28, 32, 36 and 41-43 also exceeded 10000 hours.

Although the invention has been described above in connection with several preferred embodiments therefor, it will be appreciated that those embodiments have been provided solely for illustrating the invention, and not in a limiting sense. Numerous modifications and substitutions of equivalent materials and techniques will be readily apparent to those skilled in the art after reading the present application, and all such modifications and substitutions are expressly understood to fall within the true scope and spirit of the appended claims.

What is claimed is:

1. An organic electroluminescent device including:
an anode;
a cathode;
at least one luminescent layer disposed between said anode and said cathode, and said at least one luminescent layer including at least a host material represented by a general formula (20) and at least a dopant represented by a general formula (10);
at least an electron transport layer between said at least one luminescent layer and said cathode, and said at least electron transport layer including at least a compound represented by a general formula (30),
wherein said general formula (10) is 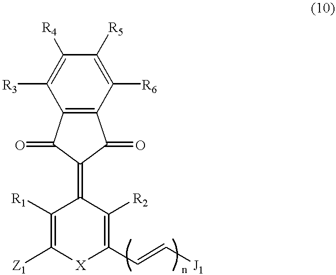
where each of R1˜R6 and Z1 is one of hydrogen atom, halogen atom, a substituted amino group, an unsubstituted amino group, a nitro group, a cyano group, a substituted alkyl group, an unsubstituted alkyl group, a substituted alkenyl group, an unsubstituted alkenyl group, a substituted cycloalkyl group, an unsubstituted cycloalkyl group, a substituted alkoxyl group, an unsubstituted alkoxyl group, a substituted aryl group, an unsubstituted aryl group, a substituted aromatic heterocyclic group, an unsubstituted aromatic heterocyclic group, a substituted aralkyl group, an unsubstituted aralkyl group, a substituted aryloxy group, and an unsubstituted aryloxy group, and X is any one of oxygen atom, sulfur atom and a chemically bonded nitrogen with G, where G is one of hydrogen atom and alkyl groups, “n” is 1 or 2, J1 is either a substituted 4-amino phenyl group or an unsubstituted 4-amino phenyl group, and the substituted and unsubstituted 4-amino phenyl groups are represented by the following general formula (10′),
wherein the general formula (20) is 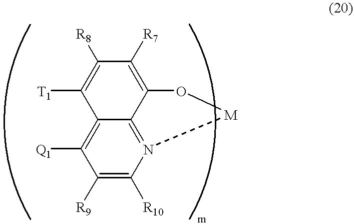
where M is aluminum atom or beryllium atom, and if M is aluminum atom, then “m” is 3, if M is beryllium atom, then “m” is 2, and each of R7˜R10, T1 and Q1 is one of hydrogen atom, halogen atom, a substituted cyano group, an unsubstituted cyano group, a nitro group, a substituted alkyl group, an unsubstituted alkyl group, a substituted alkoxyl group, an unsubstituted alkoxyl group, a substituted cycloalkyl group, an unsubstituted cycloalkyl group, a substituted aryl group, an unsubstituted aryl group, a substituted aryloxy group, an unsubstituted aryloxy group, a substituted aromatic heterocyclic group, and an unsubstituted aromatic heterocyclic group,
wherein the general formula (30) is 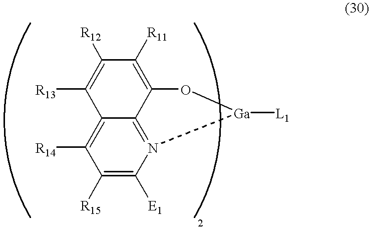
where each of R11˜R15 and E1 is one of hydrogen atom, halogen atom, a cyano group, a nitro group, a substituted alkyl group, an unsubstituted alkyl group, a substituted alkoxyl group, an unsubstituted alkoxyl group, a substituted cycloalkyl group, an unsubstituted cycloalkyl group, a substituted aryl group, an unsubstituted aryl group, a substituted aryloxy group, an unsubstituted aryloxy group, a substituted aromatic heterocyclic group, and an unsubstituted aromatic heterocyclic croup, and L1 is one of halogen atom, a substituted alkyl croup, an unsubstituted alkyl group, a substituted alkoxyl group, an unsubstituted alkoxyl group, a substituted aryl group, an unsubstituted aryl group, a substituted aryloxy group, and an unsubstituted aryloxy group, and
wherein the general formula (10′) is 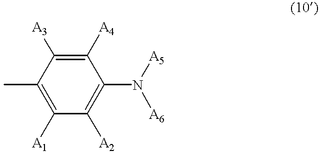
where each of A1˜A6 is one of hydrogen atom, halogen atom, a substituted amino group, an unsubstituted amino group, a nitro group, a cyano group, a substituted alkyl group, an unsubstituted alkyl group, a substituted alkoxyl group, a substituted aryl group, an unsubstituted aryl group, a substituted aryloxy group, an unsubstituted aryloxy group, a substituted aromatic heterocyclic group, and an unsubstituted aromatic heterocyclic group.

2. The organic electroluminescent device as claimed in claim 1, wherein adjacent substituted groups of Z1 and R1˜R6 are in a form of a ring.

3. The organic electroluminescent device as claimed in claim 1, wherein adjacent substituted groups of R7˜R10, T1 and Q1 are in a form of a ring.

4. The organic electroluminescent device a claimed in claim 1, wherein adjacent substituted groups of R11˜R15 and E1 are in a form of a ring.

5. The organic electroluminescent device as claimed in claim 1, wherein adjacent substituted groups of A1˜A6 are in a form of a ring.

6. The organic electroluminescent device as claimed in claim 1, wherein a thickness of said electron transport layer is in the range of 0.2-1.8 times of a thickness of said luminescent layer.

7. The, organic electroluminescent device as claimed in claim 1, further including a hole transport layer disposed between said anode and said luminescent layer.

8. The organic electroluminescent device as claimed in claim 7, wherein said hole transport layer includes an aromatic amine.

9. The organic electroluminescent device as claimed in claim 7, further including a bole injection layer disposed between said bole transport layer and said anode.

10. The organic electroluminescent device as claimed in claim 9, wherein said hole transport layer has an ionization potential level which is between a work function value of said anode and an ionization potential of said hole transport layer.

11. The organic electroluminescent device, as claimed in claim 1, further including a hole block layer disposed between said luminescent layer and said election transport layer.

12. The organic electroluminescent device as claimed in claim 1, wherein said luminescent layer further includes a matrix material of polymer to provide a high thermal stability to said luminescent layer.

13. The organic electroluminescent device as claimed in claim 1, wherein said electron transport layer further includes a matrix material of polymer to provide a high thermal stability to said luminescent layer.

14. An organic electroluminescent device including:
an anode;
a cathode;
at least one luminescent layer disposed between said anode and said cathode, and said at least one luminescent layer including at least a host material represented by a general formula (21) and at least a dopant represented by a general formula (11);
at least an electron transport layer between said at least one luminescent layer and said cathode, and said at least electron transport layer including at least a compound represented by a general formula (31),
wherein said general formula (11) is 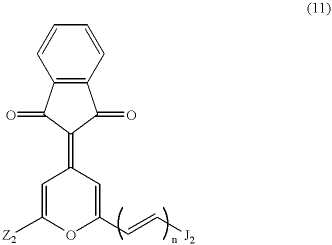
where Z2 is one of an alkyl group having a carbon number of not more than 4, a substituted cycloalkyl group, an unsubstituted cycloalkyl group, a substituted phenyl group, and an unsubstituted phenyl group, and “n” is 1 or 2, J2 is either a substituted 4-amino phenyl group or an unsubstituted 4-amino phenyl group, and the substituted and unsubstituted 4-amino phenyl groups are represented by the following general formula (11′),
wherein the general formula (21) is 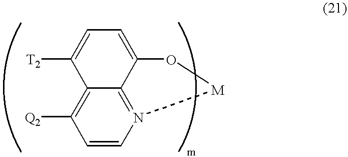
where M is aluminum atom or beryllium atom, and if M is aluminum atom, then “m” is 3, if M is beryllium atom, then “m” is 2, and each of T2 and Q2 is one of hydrogen atom, and an alkyl group having a carbon number of not more than 4,
wherein the general formula (31) is 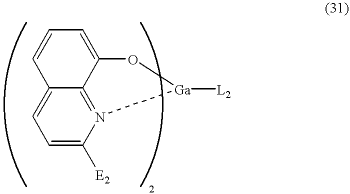
where E2 is one of hydrogen atom, and an alkyl group having a carbon number of not more than 4, and L2 is a halogen atom, a substituted phenoxyl group, an unsubstituted phenoxyl group, a substituted alpha-naphthyloxy group, a unsubstituted alpha-naphthyloxy group, a substituted beta-naphthyloxy group, an unsubstituted beta-naphthyloxy group, a substituted 2-biphenyloxy group, an unsubstituted 2-biphenyloxy group, a substituted 3-biphenyloxy group, an unsubstituted 3-biphenyloxy group, a substituted 4-biphenyloxy group, an unsubstituted 4-biphenyloxy group, a substituted 1-anthryloxy group, an unsubstituted 1-anthryloxy group, a substituted 2-anthryloxy group, an unsubstituted 2-anthryloxy group, a substituted 9-anthryloxy group, an unsubstituted 9-anthryloxy group, a substituted 1-phenanthryl oxy group, an unsubstituted 1-phenanthryl group, a substituted 2phenanthryl oxy group, an unsubstituted 2-phenanthryl group, a substituted 4-phenanthryl oxy group, an unsubstituted 4-phenanthryl group, a substituted 3-phenanthryl oxy group, an unsubstituted 3-phenanthryl group, a substituted 9-phenanthryl oxy group, and an unsubstituted 9-phenanthryl group, and
wherein the general formula (11′) is 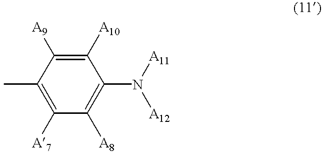
where each of A7˜A12 is one of hydrogen atom, halogen atom, a substituted amino group, an unsubstituted amino group, a nitro group, a cyano group, a substituted alkyl group, an unsubstituted alkyl group, a substituted alkoxyl group, a substituted aryl group, an unsubstituted aryl group, a substituted aryloxy group, an unsubstituted aryloxy group, a substituted aromatic heterocyclic group, and an unsubstituted aromatic heterocyclic group.

15. The organic electroluminescent device as claimed in claim 14, wherein adjacent substituted groups of A7˜A12 are in a form of a ring.

16. The organic electroluminescent device as claimed in claim 14, wherein a thickness of said electron transport layer is in the range of 0.2-1.8 times of a thickness of said luminescent layer.

17. The organic electroluminescent device as claimed in claim 14, further including a hole transport layer disposed between said anode and said luminescent layer.

18. The organic electroluminescent device as claimed in claim 17, wherein said hole transport layer includes an aromatic amine.

19. The organic electroluminescent device as claimed in claim 17, further including a hole injection layer disposed between said hole transport layer and said anode.

20. The organic electroluminescent device as claimed in claim 19, wherein said hole transport layer has an ionization potential level which is between a work function value of said anode and an ionization potential of said hole transport layer.

21. The organic electroluminescent device as claimed in claim 14, further including a hole block layer disposed between said luminescent layer and said electron transport layer.

22. The organic electroluminescent device as claimed in claim 14, wherein said luminescent layer further includes a matrix material of polymer to provide a high thermal stability to said luminescent layer.

23. The organic electroluminescent device as claimed in claim 14, wherein said electron transport layer further includes a matrix material of polymer to provide a high thermal stability to said luminescent layer.
